(19) United States
(12) Patent Application Publication
(10) Pub. No.: US 2008/0029461 A1
(43) Pub. Date: Feb. 7, 2008

(54) Proportioning, Regenerative, Rotary Pump

(76) Inventor: Buddy Don Gray, Dellrose, TN (US)

Correspondence Address: SEED INTELLECTUAL PROPERTY LAW GROUP PLLC, 701 FIFTH AVE, SUITE 5400, SEATTLE, WA, 98104, US

(21) Appl. No.: 10/534,891

(22) PCT Filed: Nov. 12, 2003
(86) PCT No.: PCT/US03/36427

§ 371 Date: Mar. 19, 2007

Related U.S. Application Data
(60) Provisional application No. 60/426,768, filed on Nov. 14, 2002.

(51) Int. Cl. C02F 1/00

(52) U.S. Cl. 210/741; 210/791

(57) ABSTRACT

A pump system for tangential flow or crossflow liquid filtration systems, such as reverse osmosis, nano, and micro filtration systems, that independently fixes the fraction of product water produced for each stage and recovers a fraction of the energy normally lost in rejected waste streams. The pump is of the rotary positive-displacement type and fixes the percent recovery of the overall system by establishing set ratios through the use of differing displacements of the various pump and motor stages, per unit of time, between the feed water inlet, product water outlet, and reject water outlet volume of each stage of the filtration system while using the same ratio setting components to recover the energy normally expelled along with the reject, or concentrate water. The pump system, while initially developed for use in water processing, can find equal or greater use in processing of fluid streams other than water and in processes other than filtration or reverse osmosis.

### BACKGROUND OF THE INVENTION

1. Field of the Invention

The present invention relates generally to a pump for use in liquid filtration systems, and more specifically to a single or multi-stage pump of the positive-displacement rotary type for controlling recovery ratios of process fluids in various stages of filtration and recovering a fraction of the energy normally lost in expelled reject or concentrate waste streams.

2. Description of Related Art

Known pumping devices for tangential or crossflow filtration or reverse osmosis filtration systems, which provide for recovery of a portion of the energy normally lost with the expulsion of the reject concentrate waste stream are disclosed in U.S. Pat. No. 4,187,173 (Keefer Feb. 5, 1980), U.S. Pat. No. Re. 32,144 (Keefer, May 13, 1986), U.S. Pat. No. 5,496,466 (Gray, Mar. 6, 1996), and U.S. Pat. No. 5,589,066 (Gray, Dec 31, 1996).

Keefer's device is a single stage piston type pump, which provides for recovery of energy normally lost to the reject waste stream. Keefer requires various combinations of complex valve mechanisms, differential surge absorbers, piston dwells, and numerous other components. Keefer teaches the use of surge absorbers and piston dwells, which prevent the device from being a true positive displacement pump and from providing a fixed recovery ratio.

In Gray '466, as in Keefer, a single stage piston type pump provides for recovery of energy normally lost to the reject waste stream. Gray teaches using one piston dedicated to pumping and a separate piston dedicated to recovering energy and controlling recovery ratios. However, as with Keefer, Gray '466 does not teach multi-stage applications of his device, and not only limits his teachings to reverse osmosis but also limits his device to hand-held portable systems.

Both Gray's and Keefer's devices have a multitude of moving parts connected with various types of linkages so as to keep the internal timings of the device in sync. An alternative to multitudes of moving parts and linkages would be a rotary type device. U.S. Pat. No. 4,966,708 (Oklejas et al.) and U.S. Pat. No. 4,983,305 (Oklejas et al.) teach the use of a turbine operatively connected to the shaft of a pump so as to recover energy normally lost to the waste steam in a process such as filtration or reverse osmosis. A turbine is by nature a non-positive displacement type device. While the amount of energy and movement transferred from a flowing stream to a turbine and its shaft is somewhat related to the amount of flow and pressure in its feed stream, it is neither directly proportional nor linear, and as such does not establish a fixed ratio between the feed and waste stream.

An alternative to the non-positive displacement devices of Oklejas et al. would be a positive displacement rotary type device. U.S. Pat. No. 5,819,554 (Glen) teaches the use of a rotary vane machine to both compress and recover fluid compression energy. Glen's device functions on the principles of the compression and expansion of a compressible fluid rather than a non-compressible fluid such as water, and therefore the amount of movement transferred from the expanding fluid to the compressible fluid varies with the fluid's compressibility. It is neither directly proportional nor linear.

Tangential flow filter systems, in particular Reverse Osmosis (RO) based systems, by their very nature have a reject or waste stream composed of concentrated contaminants that do not permeate the membrane. It is this waste stream that serves to keep the membrane surfaces swept clean of contaminants that otherwise would lead to fouling of the membrane surface and subsequent loss of flux, or permeate (product water) flow, through the membrane. It is common that single RO elements have a flux that is equal to or even less than 10% of the total feed water flow, thus resulting in the loss of 90% of the feed water. It is also common in a single stage RO system for up to 90% of the energy imparted into the feed water stream to be dissipated and lost in the expulsion of the reject waste stream. These situations result in the waste of energy, which may be in the form of a non-replenishable or otherwise costly resource, and water, which may itself be an even more costly and scarce resource.

To overcome these wastes, single stage systems attempt to recover a portion of the energy through systems such as those taught by Keefer and Gray. However, there is no appreciable increase in the amount of feed water recovered. Multi-stage systems, which directly feed the waste stream of a prior stage as the feed water to a subsequent stage, which in turn feeds its waste stream to a subsequent stage, and so on for the total number of stages in the system, recover approximately 40% of the initial feed water flow using 5 stages. With a 99% rejection of contaminants, the last stage of the system will see a concentration of contaminants in its feed water that is 1.6 times that in the first stage. This means that the pressure of the initial feed water must be in the area of 1.6 times higher than that required for the first stage, plus any pressure drops throughout the system. This results in greater energy consumption as well as the subjection of the initial stages of elements to pressures higher than would otherwise be required, resulting in premature failure or higher costs for membranes, housings, and pumps to withstand the higher pressures.

In multi-stage systems, as the quality of the initial feed water varies and as the performance of the individual stage elements diminishes, the back pressures on the reject streams required to maintain the proper recovery rate must be adjusted. It is difficult and time consuming to precisely adjust and maintain the pressures and recovery rates of the individual stages, and it is costly to provide the controls necessary to perform this task. This results in most multi-stage systems operating at less than their peak performance.

Therefore, a need exists for a device that will allow a single or multi-stage tangential flow filtration system, and in particular an RO based system, to recover a substantial portion of the energy lost in the expelled waste stream while (1) maintaining proper feed water to concentrate and permeate ratios and pressures for the various stages, (2) keeping component count and complexity to a minimum, and (3) providing a high degree of reliability.

### BRIEF SUMMARY OF THE INVENTION

The disclosed embodiments of the invention are directed to a method and system for recovering and utilizing waste energy in a filtration system. In accordance with one embodiment of the invention, a pump is provided that receives feed water at an inlet, the feed water being drawn through the pump by a rotor within the pump body and exiting as pressurized water into a reverse osmosis filter that is configured to separate a purified portion of water as product water that exits the filter via an outlet and unpurified, concentrated waste water that exits the filter, and a motor that receives the waste water and includes an impeller that is driven by the waster water, and a connection element that connects the output of the motor to an input of the pump to recover a portion of the energy originally utilized to bring the water up to the pressurized condition.

In accordance with an aspect of the foregoing embodiment, the connection between the motor and the pump comprises a mechanical coupling. Ideally the mechanical coupling prevents slippage to enable establishing a ratio of the feed water to the product water.

In accordance with a method of the present invention, feed water is drawn into a pump configured to pressurize the feed water; the pump forces the feed water into a reverse osmosis filter; the reverse osmosis filter separates the feed water into purified product water and unpurified waste water; the waste water is fed into a motor to drive the motor; and the output of the motor is mechanically coupled to the pump to recover energy from the waste water and establishing the feed water to product water recovery ratio.

As will be readily appreciated from the foregoing, the disclosed embodiments of the regenerative pump have the ability to function as an integral part of either a single stage or a multi-stage tangential flow filtration system. It enables recovery of a substantial portion of the energy lost in the expelled waste stream. Despite varying feed water quality and degradation of individual filtration elements, the pump maintains proper feed water to concentrate and permeate ratios and individual stage pressures.

Although it can work with nano, micro, and other types of tangential flow filtration systems, it is particularly suited for reverse osmosis based systems. A filtration system formed in accordance with the present invention will achieve the foregoing advantages while keeping component count and complexity to a minimum and while providing a high degree of reliability through the use of a positive displacement rotary type device.

The regenerative pump disclosed herein satisfies the need for a device that will allow a single or multi-stage tangential flow filtration system, including reverse osmosis based systems as well as nano and micro filtration based systems, to recover a substantial portion of the energy normally lost along with the concentrate reject waste stream, to maintain proper concentrate to permeate ratios, and to maintain proper pressures for the different stages of the system in spite of changes in feed water quality and changes in membrane performance. The invention satisfies these needs while keeping component count and complexity to a minimum and while providing a high degree of reliability. The invention satisfies these needs by utilizing rotary type, positive displacement type devices, thus, eliminating much of the complexity and limitations of prior art.

### BRIEF DESCRIPTION OF THE SEVERAL DRAWINGS

The foregoing features and advantages of the disclosed embodiments of the invention will be more readily appreciated as the same become better understood from the following detailed description when taken in conjunction with the following drawings, with like reference numerals denoting like elements, wherein:

FIG. 1 depicts a reverse osmosis system with a single stage rotary pump with ratio fixing, energy recovery motor; and

FIG. 2 depicts a four stage reverse osmosis system with one pump, three combination pump-and-motor units, and one motor.

### DETAILED DESCRIPTION OF THE INVENTION

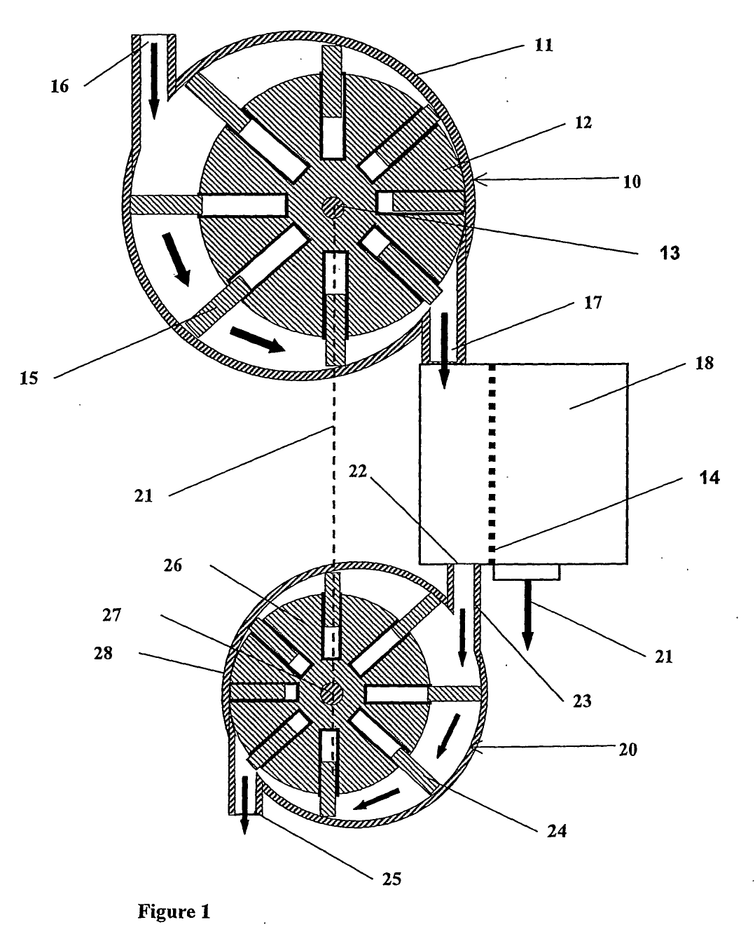

Illustrated in FIG. 1, which is not drawn to any singular scale, is a cross-section of a pump 10 formed in accordance with one embodiment of the invention. The pump 10 includes a pump body 11, which contains the pump rotor 12 and a plurality of pump vanes 15. The rotor 12 is connected to a motive force (not shown) via a pump drive shaft 13. The pump 10 comprises a conventional rotary vane pump that is readily commercially available and known to those skilled in the art. Hence, the pump 10 will not be described in greater detail herein. It should be noted, however, that the vanes 15 are slideably received within the rotor 12 for radial movement as the rotor 12 rotates within the housing or body 11.

As the rotor 12 rotates counter clockwise, feed water is drawn through a pump inlet 16 and into the pump body 11, where, as the rotor 12 continues to rotate, the vanes 15 begin to squeeze the water, causing it to become pressurized. As the rotor 12 continues to rotate, the pressurized water exits the pump body 11 through a pump outlet 17. From the outlet 17, the pressurized water enters a reverse osmosis element 18, where it flows tangentially to the RO membrane 14, effectively separating a purified portion of water, which exits the element 18 through a product water outlet 21, while the unpurified, and now more concentrated portion of the water, exits the element 18 at a waste water outlet 22. This water exiting the outlet 22 is pressurized to the pressure generated within the pump body 11, less any pressure lost to restrictions and through the membrane 14.

Also illustrated in FIG. 1 is a motor 20 that includes a motor body 28, which serves mainly to contain a motor rotor 26 and motor vanes 24. The rotor 26 is connected through a motor drive shaft 27 and pump to a motor connection (shown as a dashed line 42), to the same motive force (not shown) as the pump drive shaft 13, effectively mechanically coupling the pump 10 and the motor 20 together.

For this example, assume the total displacement of the motor 20 to be 90% of the total displacement of the pump 10. As the pressurized water flows through the RO element 18 and out the waste water outlet 22, it enters the motor 20 at the motor inlet 23. Since the total displacement of the motor 20 is 90% of the displacement of pump 10, and since the pump 10 and the motor 20 are mechanically coupled, the volume above the displacement of the motor 20 is forced to flow through the area of least resistance, which in this case is the RO membrane 14. For this example, assume the water is sea water requiring a pressure of 1000 psig for purified water to permeate the RO membrane 14. With a total of 100 psig lost to restrictions and flow through the RO membrane 14, the resulting pressure at the waste water outlet 22 and subsequent inlet 23 is 900 psig. As this 900 psig enters the motor body 28, and before passing out the motor waste outlet 25, it exerts pressure on the vanes 24, causing a clockwise rotation of the motor rotor 26 and shaft 27 coupled thereto, as viewed in FIG. 1. Thus, the rotation of the respective rotors 12, 26 in the pump 10 and the motor 20, after coupling via connection 42, are, for this example, in the same direction. Because the motor shaft 27 is coupled to the pump shaft 13, the motion caused by the force of the pressurized water causes the pump rotor 12 to rotate, effectively regenerating a portion of the energy originally utilized to bring the water up to the original 1000 psig.

As can be seen from the above example, the combined pump and motor mechanism effectively regenerates the energy from the waste that would be normally lost, while at the same time establishing the feed water to product water recovery ratio.

While the above example utilized a motor 20 that is proportionally smaller than the pump 10 in total displacement, and which is directly connected to the pump drive, the utilization of an indirect, yet positive, coupling which is in itself capable of establishing the required ratios per unit of time, would allow identically-sized, or for that mater, inversely proportional pump and motor combinations. The coupling mechanism itself could be variable, thus allowing the pump-to-motor ratio to be changed, in effect changing the recovery ratio of the water. And, while the preferred embodiment utilizes positive coupling between the pump and the motor, it is envisioned that some applications could benefit from a non-positive coupling between the two mechanisms.

And, while the pump 10 and the motor 20 of the above example are shown to be of a rotary vane type, essentially any type of positive displacement rotary pump or motor combination, whether matched or mixed, are capable of functioning in this embodiment.

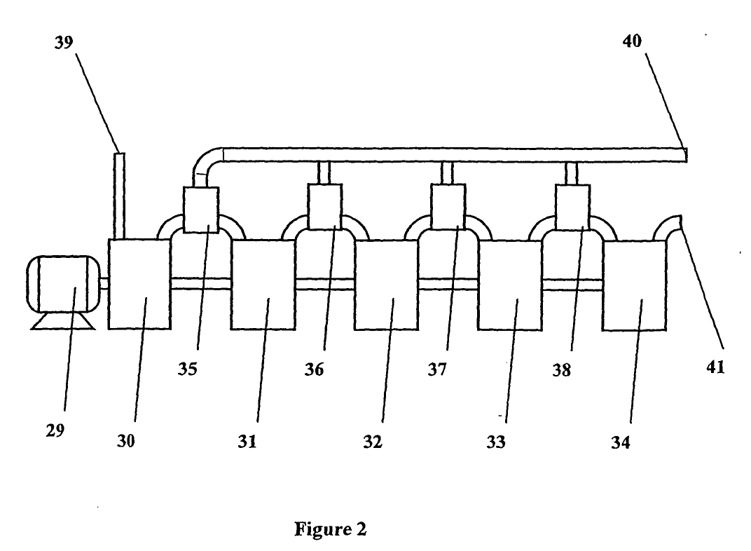

Also, while the example above teaches a single stage pump and motor combination, a multiple stage system is possible as depicted in FIG. 2, where a common motive force 29 is either directly or indirectly mechanically coupled to a pump 30, to combination pump-and-motor units 31, 32, and 33, and to a motor 34. The combination pump-and-motor units 31, 32, and 33 are preferably each a singular mechanism that has the ability to function either simultaneously or alternatively as either a pump or a motor or both, but may also be dedicated pumps coupled to dedicated motors, or the units may be capable of multiple functions, yet only perform a single dedicated task.

As raw water is fed into the inlet 39 of the pump 30, it is pressurized and fed into the RO element 35. The product from the RO element 35 exits the system through a product water outlet 40, while the waste is fed into the first pump-and-motor unit 31, which for example has a total displacement of 90% of the pump 30, where the recovery fraction of 10% is established for the element 35. The normally wasted energy is recovered and simultaneously inputted back into the water, which now becomes the feed water for the RO element 36 as it is pumped out of the first pump-and-motor unit 31.

The product water from the element 36 again exits through the outlet 40, while the waste is fed into the second pump-and-motor unit 32, which, as in the above example, has a total displacement of 90% of the first pump-and-motor unit 31, where the recovery fraction of 10% is again established, this time for element 36. The normally wasted energy is again recovered and simultaneously inputted back into the water, which now becomes the feed water for the RO element 37 as it is pumped out of the second pump-and-motor unit 32. The product water from the RO element 37 again exits through the outlet 40, while the waste is fed into the third pump-and-motor unit 33, which for example, has a total displacement of 90% of the second pump-and-motor unit 32, where the recovery fraction of 10% is again established, this time for element 37. The normally wasted energy is again recovered and simultaneously inputted back into the water, which now becomes the feed water for the RO element 38 as it is pumped out of the third pump-and-motor unit 33. The product water from the RO element 38 exits through the outlet 40, while the waste is fed into the motor 34, which for example, as in the above example, has a total displacement of 90% of the third pump-and-motor unit 33, where the recovery fraction of 10% is again established, this time for element 38. The normally wasted energy is again recovered and simultaneously inputted back into the common motive force 29, effectively regeneratively recovering the energy that would have normally been wasted down the drain.

While the foregoing example shows four stages of reverse osmosis, there is no limit to the number of stages except as where practicality governs. It should be appreciated, that as the percentage of recovery of the initial feed water increases, the percentage of recovery of the initial energy input decreases essentially proportionally. Therefore, the stage number practicality is greatly influenced by the scarcity of feed water, the expense of power, and the expense of any pretreatment applied to the initial feed water.

1. A method for filtering liquid utilizing a proportioning, regenerative rotary pump configuration, comprising:
introducing feed liquid into a pump;
pressurizing the feed liquid in the pump;
feeding the pressurized liquid from the pump to a reverse osmosis filter;
dividing the liquid in the filter into product liquid and waste liquid;
feeding the waste liquid to a motor to drive the motor; and
mechanically coupling the motor to the pump to recover energy from the waste liquid and establish a ratio of feed liquid to product liquid.

2. A liquid filtration system, comprising:
a pump configured to receive feed water and to pressurize the feed water at an outlet therefrom;
a filter coupled to the outlet of the pump and configured to receive the pressurized feed water and to divide the pressurized feed water into waste water and purified product water;
a motor having an input coupled to the filter to receive the waste water and configured to be driven by the waste water; and
a mechanical coupling configured to couple the output of the motor to an input of the pump to recover a portion of the energy used to pressurize the feed water and to establish a ratio of the feed water to the product water.

3. The method of claim 1, comprising providing a motor having a displacement and a pump having a displacement, wherein the ratio of the motor displacement to the pump displacement is 90%.

4. The method of claim 1, wherein the motor and the pump each comprise a rotary vane type.

5. The method of claim 1, wherein the ratio of product liquid to feed liquid is 90%.

6. The method of claim 1, wherein mechanically coupling comprises directly coupling the motor to the pump with a positive mechanical coupling.

7. The method of claim 1, wherein mechanically coupling comprises a variable coupling to enable varying of the pump-to-motor ratio.

8. The method of claim 1, wherein mechanically coupling comprises a non-positive mechanical coupling.

9. The method of claim 1, comprising coupling combination pump-and-motor units in series to provide a multiple stage system.

10. The method of claim 9, comprising coupling the product liquid outputs from each pump-and-motor unit to a common output line.

11. The method of claim 10, comprising coupling a waste water output from a reverse osmosis filter in each unit to an input of a succeeding unit.

12. The method of claim 1, wherein the motor and the pump each have a displacement, and the ratio of the motor displacement to the pump displacement is 90%.

13. The method of claim 2, wherein the motor and pump each comprise a rotary vane type.

14. The method of claim 2, wherein the ratio of product liquid to feed liquid is 90%.

15. The system of claim 2, wherein the mechanical coupling comprises a direct coupling.

16. The system of claim 2, wherein the mechanical coupling comprises a variable coupling to enable varying of the pump-to-motor ratio.

17. The system of claim 2, wherein the mechanical coupling comprises a non-positive mechanical coupling.

18. The system of claim 2, wherein the mechanical coupling comprises a positive mechanical coupling.

19. The system of claim 2, comprising multiple pump-and-motor units coupled together in series.

20. The system of claim 19, wherein the product liquid output from each pump-and-motor unit is coupled to a common output, and the waste water output from each pump-and-motor unit is coupled to an input of a succeeding pump-and-motor unit.
